(19) United States
(12) Patent Application Publication
(10) Pub. No.: US 2011/0064897 A1
(43) Pub. Date: Mar. 17, 2011

(54) Personalizable Stationery Assemblies and Methods

(76) Inventor: Nicholas J. Aynsley, Seattle, WA (US)

(21) Appl. No.: 12/887,355

(22) Filed: Sep. 21, 2010

Related U.S. Application Data
(63) Continuation-in-part of application No. 12/341,914, filed on Dec. 22, 2008.
Application No. 12/341,914 is a continuation of application No. 11/708,913, filed on Feb. 20, 2007, now abandoned.

(51) Int. Cl. B32B 1/04

(52) U.S. Cl. 428/34.1

(57) ABSTRACT

A customizable stationery item adapted to hold supplemental material, comprising at least one backing sheet, adhesive material, a face sheet, and a release strip. The adhesive material is applied to the backing sheet to define first, second, third, and fourth portions arranged to define a material chamber. The face sheet is secured to the backing sheet by the first, second, and third portions of the adhesive material. The release strip selectively engaged with the fourth portion of the adhesive material to define a material opening. After the supplemental material is inserted into the material chamber through the material opening, the release strip is removed to allow the face sheet to contact the fourth portion of the adhesive material, thereby closing the material opening.

### RELATED APPLICATIONS

This application (Attorney's Ref. No. P216554) is a continuation-in-part of U.S. patent application Ser. No. 12/341,914 filed Dec. 22, 2008.

U.S. patent application Ser. No. 12/341,914 is a continuation of U.S. patent application Ser. No. 11/708,913, filed Feb. 20, 2007, now abandoned.

The contents of all related applications listed above are incorporated herein by reference.

### TECHNICAL FIELD

The present invention relates to calendar assemblies and, more specifically, to calendar assemblies that can easily be personalized with supplemental materials.

### BACKGROUND

Calendars for a primary time period, typically a year, are conventionally sold with one or more calendar images representing a sub time period, typically a month. The images representing the sub time periods may be formed on one or more sheets of paper, but are very often formed with one sub time period formed on a separate sheet of paper. The separate sheets of paper are often bound or otherwise joined using spiral paper connectors.

Calendar publishers have long recognized that calendars comprising a plurality of separate sheets of paper bound by spiral paper connectors present the opportunity for the display of fanciful images in tandem with one or more calendar image. The fanciful images may follow a theme or interest (automobiles), may be associated with a particular month or season (flowers in spring, snow scenes in winter), or in some case may be custom printed for distribution by a particular customer.

Given the costs of printing in small quantities, calendar publishers have difficulty producing calendars customized for individualized users. Computer software may assist in the product of small quantities of calendars for individualize users, but this software may be inconvenient or difficult for some to customers to use.

The need thus exists for calendars that allow customers to create customized calendars in small quantities simply and inexpensively.

### SUMMARY

The present invention may be embodied as a customizable stationery item adapted to hold supplemental material, comprising at least one backing sheet, adhesive material, a face sheet, and a release strip. The adhesive material is applied to the backing sheet to define first, second, third, and fourth portions arranged to define a material chamber. The face sheet is secured to the backing sheet by the first, second, and third portions of the adhesive material. The release strip selectively engaged with the fourth portion of the adhesive material to define a material opening. After the supplemental material is inserted into the material chamber through the material opening, the release strip is removed to allow the face sheet to contact the fourth portion of the adhesive material, thereby closing the material opening.

### BRIEF DESCRIPTION OF THE DRAWINGS

FIG. 1 is a front elevation view of an example calendar assembly of the present invention in a closed position;

FIG. 2 is a side elevation view of the example calendar assembly of FIG. 1;

FIG. 3 is a first side elevation view illustrating movement of individual pages of the example calendar assembly of FIG. 1;

FIG. 4 is a second side elevation view illustrating movement of individual pages of the example calendar assembly of FIG. 1;

FIG. 5 is a front elevation view of the example calendar assembly of FIG. 1 in an open configuration;

FIG. 6 is a partial front elevation view of the example calendar assembly of FIG. 1 illustrating insertion of a supplemental material in the form of a photograph into a material chamber;

FIG. 7 is a front elevation view similar to FIG. 6 illustrating an optional process of sealing the supplemental material within the material chamber;

FIG. 8 is a section view taken along lines 8-8 in FIG. 7 illustrating the supplemental material sealed within the material chamber;

FIGS. 9-11 are section views taken along lines 9-9 in FIG. 7 illustrating the details of one example of the optional process of sealing the supplemental material within the material chamber;

FIG. 12 is a front elevation view of a desktop stationery item of the present invention;

FIG. 13 is a section view taken along lines 13-13 in FIG. 12 showing the desktop stationery item of FIG. 12 in a storage configuration;

FIG. 14 is a section view similar to FIG. 13 showing the desktop stationery item of FIG. 12 in a display configuration;

FIGS. 15-16 are front elevation views of showing the process of adding supplemental material to the desktop stationery item of FIG. 12;

FIG. 17 is a section view of a display sheet assembly of the desktop stationery item of FIG. 12 containing the supplemental material;

FIGS. 18-20 are side elevation views of a portion of FIG. 17 depicting the process of sealing a material chamber containing the supplemental material;

FIG. 21 is a front elevation view of a hanging stationery item of the present invention;

FIG. 22 is a section view taken along lines 22-22 in FIG. 21;

FIG. 23 is a section view of a display sheet assembly of the desktop stationery item of FIG. 12 containing the supplemental material;

FIGS. 24-26 are side elevation views of a portion of FIG. 23 depicting the process of sealing a material chamber containing the supplemental material;

FIG. 27 is a front elevation view of a folding stationery item of the present invention;

FIG. 28 is a section view taken along lines 28-28 in FIG. 27; and

FIGS. 29-31 are side elevation views of a portion of FIG. 28 depicting the process of sealing a material chamber containing the supplemental material.

### DETAILED DESCRIPTION

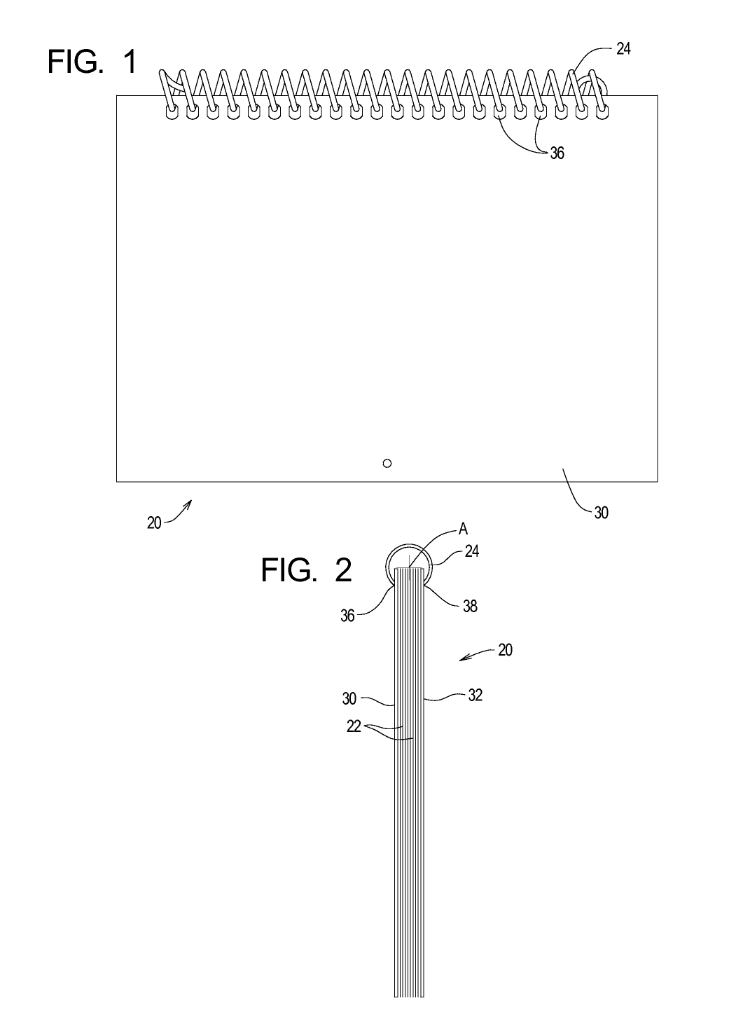

Depicted at FIGS. 1-7 of the drawing is a calendar assembly 20 constructed in accordance with, and embodying, the principles of the present invention. The example calendar assembly 20 comprises a plurality of pages 22 and a binder member 24. The example calendar assembly 20 further comprises optional front and rear cover members 30 and 32. Holes 34, 36, and 38 are formed in the pages 22 and cover members 30 and 32, respectively, and the binder member extends through these holes 34-38 to join the pages 22 and cover members 30 and 32 together as will be described in further detail below.

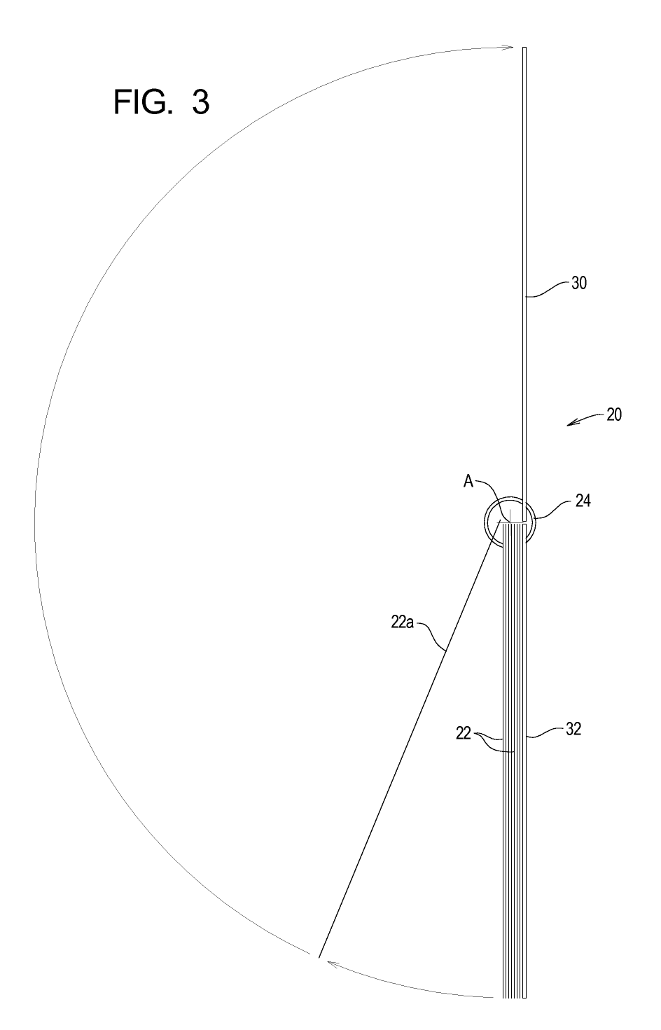

The example calendar assembly 20 may be arranged in a closed configuration as shown in FIGS. 1 and 2 for retail sale and storage or in an open configuration as shown in FIGS. 3-8. The calendar assembly 20 is typically used in the open configuration as will be explained in further detail below.

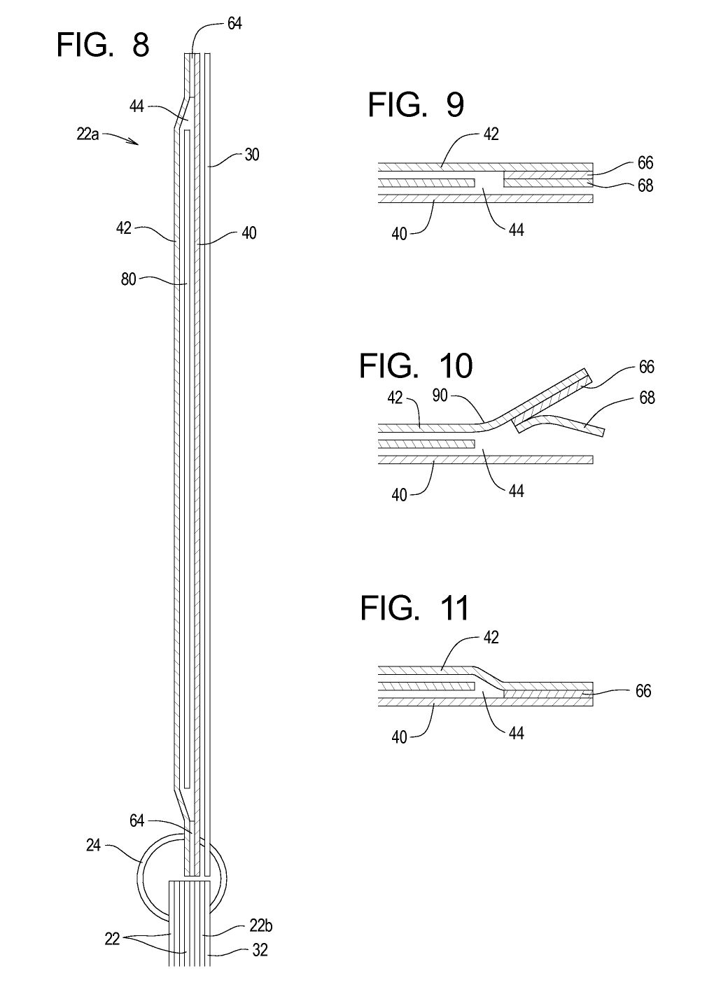

Referring now to FIG. 8, an example of one of the pages 22 is depicted in detail therein. The page 22 depicted in FIG. 8 comprises a backing sheet 40 and a face sheet 42. The face sheet 42 is joined to the backing sheet 40 to define a material chamber 44.

The backing sheet 40 is sufficiently rigid to maintain the entire page 22 in a substantially planar configuration during normal use. The backing sheet 40 defines an inner surface 40a and an exposed surface 40b. When the pages 22 are used in the context of the calendar assembly 20, the exposed surface 40b of at least one of the backing sheets 40 is imprinted with a calendar image 46 represented with a period of time such as a day, week, month, or year.

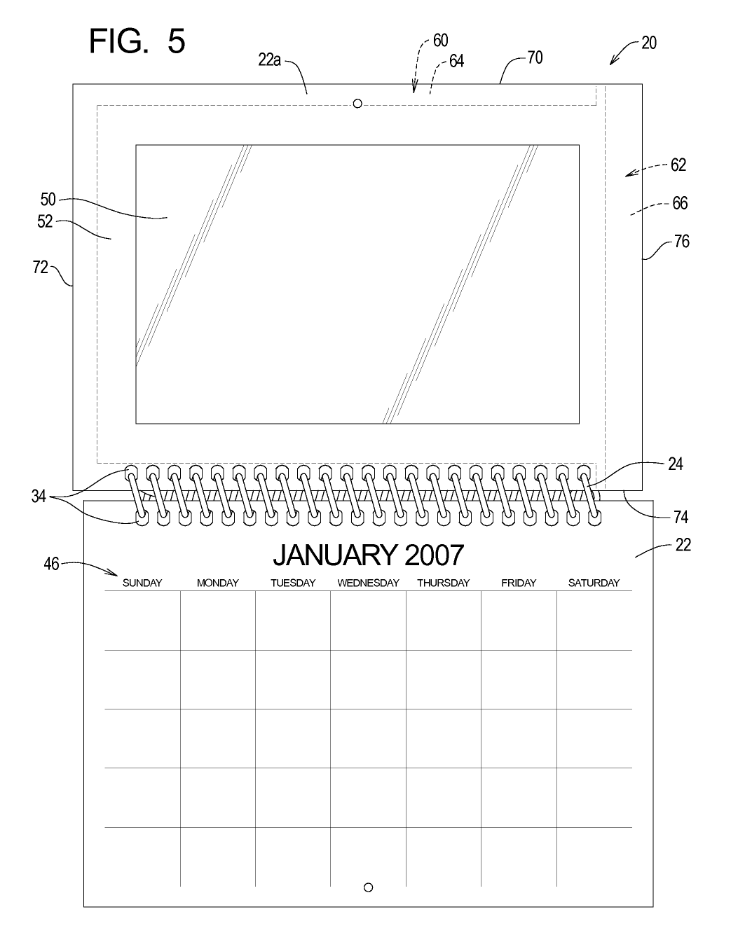

The example calendar assembly 20 depicted in FIGS. 5-7 contains thirteen of the pages 22, and FIGS. 5-7 illustrate the calendar image 46 representing the month of January 2007. The page 22 adjacent to the front cover 30 will be referred to herein as a leading page 22a. A leading page 22a need not have a calendar image formed on the exposed surface 40b of the backing sheet 40 thereof.

The page 22 adjacent to the rear cover 32 will be referred to herein as a trailing page 22b and could be manufactured with only a backing sheet 40 (without a face sheet 42) or with both a backing sheet 40 and a face sheet 42. In the example calendar assembly 20, a calendar image (December 2007) is formed on the exposed surface 40b of the backing sheet 40 of the trailing page 22b.

The middle eleven pages 22 of the example calendar assembly 20 are intermediate pages 22 having both a face sheet 42 and a calendar image 46 formed on the exposed surface 40b of the backing sheet 40.

The example face sheet 42 used by the leading page 22a and the intermediate pages 22 is relatively flexible and is at least partly see-through, as perhaps best shown in FIGS. 5-7. The example face sheet 42 of the leading page 22a or any of the intermediate pages 22 is associated with the calendar image 46 on the exposed surface 40b of the trailing page 22b or one of the intermediate pages 22. In the context of the example calendar assembly 20, each month represented by the calendar image is associated with one of the face sheets 42.

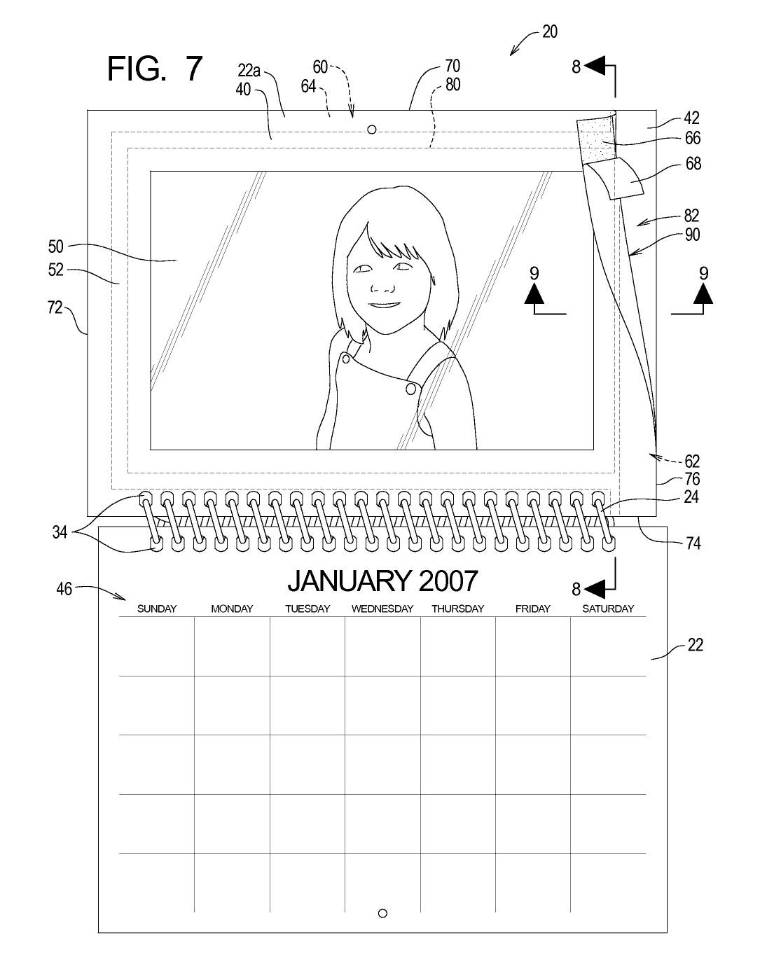

In the context of the example calendar assembly 20, the associated face sheet 42 of one page 22 faces the associated calendar image 46 of the page 22 adjacent thereto when the calendar assembly 20 is in its closed configuration as shown in FIGS. 1 and 2. When the calendar assembly 20 is in its open configuration as shown in FIGS. 3-7, the face sheet 42 and its associated calendar image 46 are substantially coplanar and thus both visible. FIGS. 5 and 7 perhaps best illustrate what the user will see when the calendar assembly 20 is in its open position.

With the foregoing general understanding of the present invention in mind, the details of construction and operation of the example calendar assembly 20 will now be described in further detail.

As perhaps best shown in FIG. 3, the example binder member 24 maintains the pages 22 in a substantially parallel relationship but allows rotation of these pages 22 relative to each other about a binding axis A. The example binder member 24 also maintains the cover members 30 and 32 in a substantially parallel relationship with each other and the pages 22 and allows the cover members 30 and 32 to rotate relative to each other and the pages 22 about the binding axis A. The binder member 24 is conventional in that it is formed by a spiral member that extends through successive holes 34-38.

The example backing sheet 40 of the pages 22 is made of thick paper, card stock, or card stock. The backing sheet 40 may be made of other materials depending upon factors such as cost, weight, rigidity, environmental conditions, and aesthetics. For example, if the calendar assembly 20 is intended for use in a wet or humid environment, the backing sheet 40 may be made of a sheet of plastic or metal that is less likely to lose rigidity when wet.

The example face sheet 42 is made of solid sheet of plastic. The plastic sheet forming the example page 22 comprises a first portion 50 that is substantially transparent and a second portion 52 that is substantially opaque.

The second portion 52 is in the shape of a border that extends around the first portion 50. The example face sheet 42 is rectangular, and the second portion 50 takes the form of a rectangular border that extends around all four sides of the first portion 50. The example first portion 50 is thus also rectangular. The face sheet 42 may be made by, for example, printing on a clear sheet of plastic, where the printed area defines the second portion 52 and the unprinted area forms the first portion 50.

Where no overlaid border around the first portion 50 is required or desired, the second portion 52 may be eliminated. In this case, the face sheet 42 may be made of a clear sheet of material without any substantial printed portion. In addition, the second portion 52 may take forms other than a border extending completely around all four edges of the first portion 50. For example, the second portion 52 may extend along fewer than four edges of the first portion 50, may be an irregular shape that defines a non-rectangular first portion 50 (e.g., circular or oval), and/or may take the form of printed words, graphics, or the like that overlays the first portion 50 in some way that is aesthetically desirable.

Alternatively, the face sheet 42 may be made by a solid and/or opaque to sheet of material. With the face sheet 42 being made of solid and/or opaque material, the solid and/or opaque material may be attached to the backing sheet 40 such that the backing sheet 40 is not visible through the face sheet 42.

More likely, however, the face sheet 42 made of solid and/or opaque material will be processed such that a portion is removed to define an opening in the face sheet 42. In this case, the opening defines the first portion 50 and the remaining material of the solid and/or opaque sheet defines the second portion 52. A face sheet 42 in which the first portion 50 is defined by an opening may be made of materials, such as paper, cardstock, or the like, that are not inherently transparent. As with a printed second portion 52 as described above, a second portion 52 formed by removing material of a solid and/or opaque sheet may define a first portion 50 in shapes other than rectangular.

Referring now more specifically to FIG. 5 of the drawing, broken lines therein illustrate that the example page 22 comprises a first adhesive region 60 and an optional second adhesive region 62. First and second layers of adhesive material 64 and 66 applied to one or both of the backing sheet 40 and/or face sheet 42 within the example first and second adhesive regions 60 and 62. The example page 22 further comprises an optional release sheet 68 arranged in contact with the second adhesive layer 66 within the second adhesive region 62.

The example page 22 is rectangular and thus defines first, second, third, and fourth edges 70, 72, 74, and 76. The example first adhesive region 60 extends substantially along the first, second, and third edges 70, 72, and 74 of the page 22. In the example page 22, the first adhesive region 60 is formed such that face sheet 42 is adhered, at the time the page 22 is manufactured, to the backing sheet 40 substantially along the first, second, and third edges 70, 72, and 74.

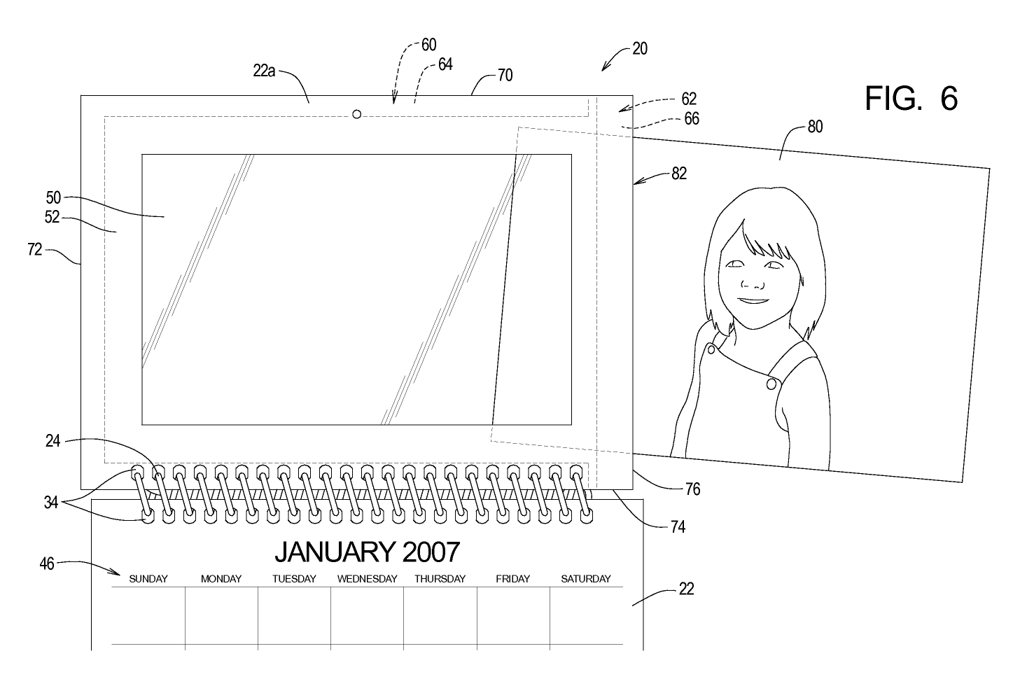

With the face sheet 42 adhered to the backing sheet 40, the page 22 defines a material chamber 44 between the backing sheet 40 and the face sheet 42. A supplemental material 80 may be arranged within the material chamber 44. More specifically, FIG. 6 illustrates the process of inserting a supplemental material 80 taking the form of a photograph into the material is chamber 44 through a chamber opening 82 defined between the backing and face sheets 40 and 42 along the fourth edge 76.

The supplemental material 80 may take forms other than a photograph as depicted and described herein. As examples, the supplemental material 80 may take the form of a document commemorating a certain event, a printed page containing an inspirational passage or phrase, a sheet of material on which art or crafts is formed, or generally flat but three-dimensional items such as flowers, leaves, keepsakes, or the like. Another example of a supplemental material 80 that may be inserted into the material chamber 44 would be to include an envelope containing a letter, cash, and/or a check.

In the case of a photograph, at least a portion of the photograph is visible through the substantially transparent first portion 50. In the example page 22 and supplemental material 80 depicted in FIG. 7, the photograph is slightly larger than the first portion 50 of the face sheet 42. The substantially opaque second portion 52 thus forms a border that obscures the edges of the photograph. A substantial portion of the photograph is thus visible through the face sheet 42, but the photograph may be arranged relative to the first portion 50 to frame the photograph in a desirable manner.

The form factor of the supplemental material 80 need not be larger than the area of the first portion 50, however. In this case, the inner surface 40a of the backing sheet 40 will define a background against which the supplemental material 80 is displayed. The colors of the second portion 52 and the inner surface 40a should thus be complementary with each other and with the supplemental material 80. Optionally, a separate background sheet (not shown) may be inserted into the material chamber 44 at least partly behind and/or at least partly in front of the supplemental material 80 to enhance the display of the supplemental material 80.

The example second adhesive region 62 extends substantially along a is fourth edge 76 of the page 22. The second adhesive region 62 is not required for any particular implementation of the present invention but is used in situations when it is desirable to at least partly close the chamber opening 82.

If used, the second adhesive region 62 is formed such that the chamber opening 82 may be closed after the supplemental material 80 is inserted into the chamber 44 through the chamber opening 82. In the example page 22, the second layer 66 of adhesive material is applied to one or the other of the backing sheet 40 and face sheet 42 within the second adhesive region 62. The release sheet 68 has a surface area at least as large as the second adhesive region 62 and is applied over the second layer 66 of adhesive material. The release sheet 68 prevents the face sheet 42 from bonding to the backing sheet 40 along the fourth sheet edge 76 at the time of manufacture of the page 22.

The chamber opening 82 thus remains open until the calendar assembly 20 is to be used by the user. At that point, the user may insert any desired supplemental material 80 into the material chamber 44 through the chamber opening 82 as shown in FIG. 6.

In the example page 22, the second layer of adhesive material 66 is formed on the face sheet 42. If the user wishes to close the material chamber 44, a fold 90 is formed in the face sheet 42 to expose the release sheet 68. As is conventional, the release sheet 68 is formed of a material that does not bond well with the adhesive material 66. The exposed release sheet 68 may thus be peeled away from the adhesive material 66 as shown in FIGS. 7 and 10.

Once the release sheet 68 is removed, the face sheet 42 is folded back so that the adhesive material 66 comes into contact with the backing sheet 40. The adhesive material 66 is a pressure sensitive adhesive formulated to bond well with the backing sheet 40, so the adhesive material 66 adheres the face sheet 42 to the backing sheet 40 along the fourth edge 76, thereby effectively closing the chamber opening 82.

Systems and methods of closing the chamber opening 82 other than a pressure sensitive adhesive and release sheet may be used by a page assembly of the present invention. In particular, the face sheet 42 may be joined to the backing sheet 40 using external integrally formed clips, external or integrally formed rivets, integrally formed folds or cuts in one or both of the sheets 40 and 42, and/or liquid adhesive applied to one or both of the sheets 40 and 42.

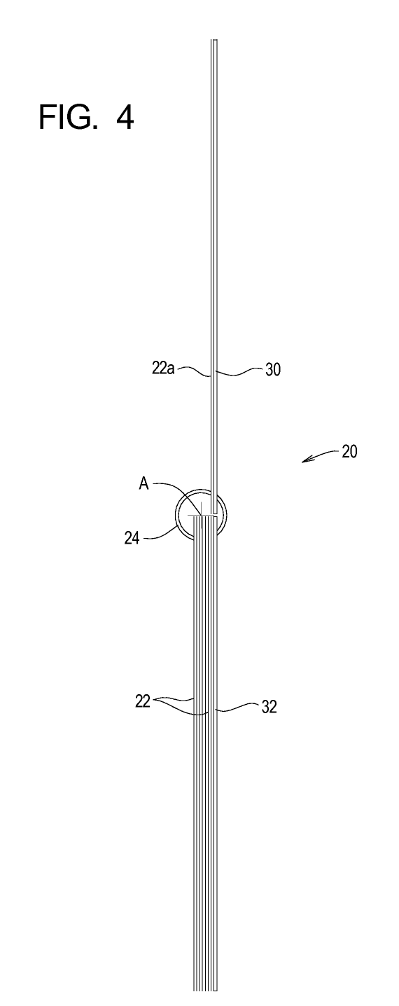

While the pages 22 have significant utility on their own, they are of primary significance in the context of the calendar assembly 20 as described above. However, pages 22 may be joined or associated with each other using means other than the binder member 24 described above. For example, a frame may be provided, and two or more pages 22 may be supported by the frame in a planar relationship similar to that depicted in FIGS. 4, 5, and 7. In addition, instead of having one page for each month, a calendar assembly of the present invention might be implemented with only one of the pages 22 and twelve tear-away sheets, one for each month. The pages 22 may be used for purposes other than forming a calendar assembly.

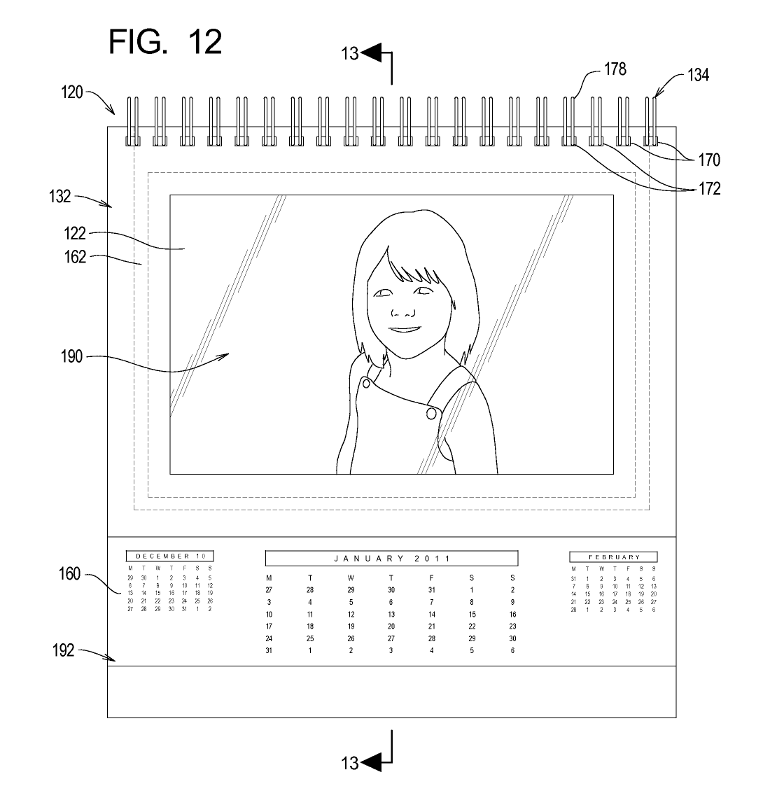

Turning now to FIGS. 12-20, depicted at 120 therein is an example desktop stationery item constructed in accordance, and embodying, the principles of the present invention in one form. supplemental material 122 is supported by the stationery item 120.

The example desktop stationery item 120 comprises a support board to 130, one or more display sheet assemblies 132, and a binding system 134. The example binding system 134 secures the display sheet assemblies 132 relative to each other and to the support board 130.

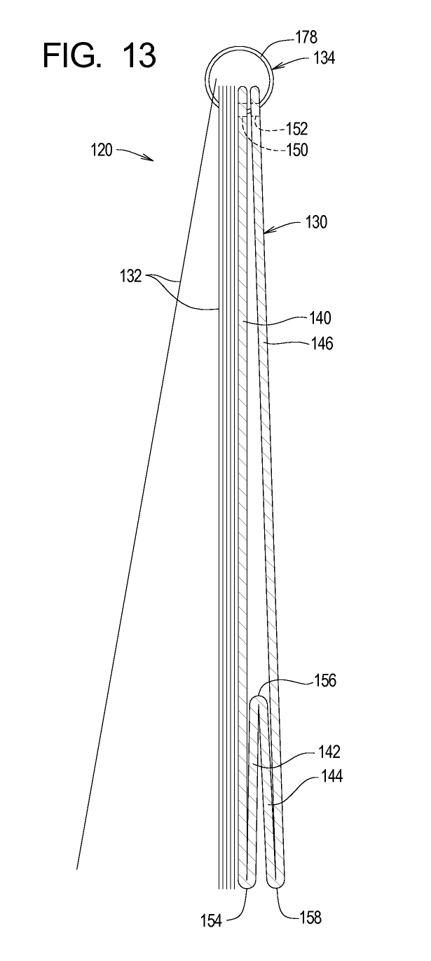

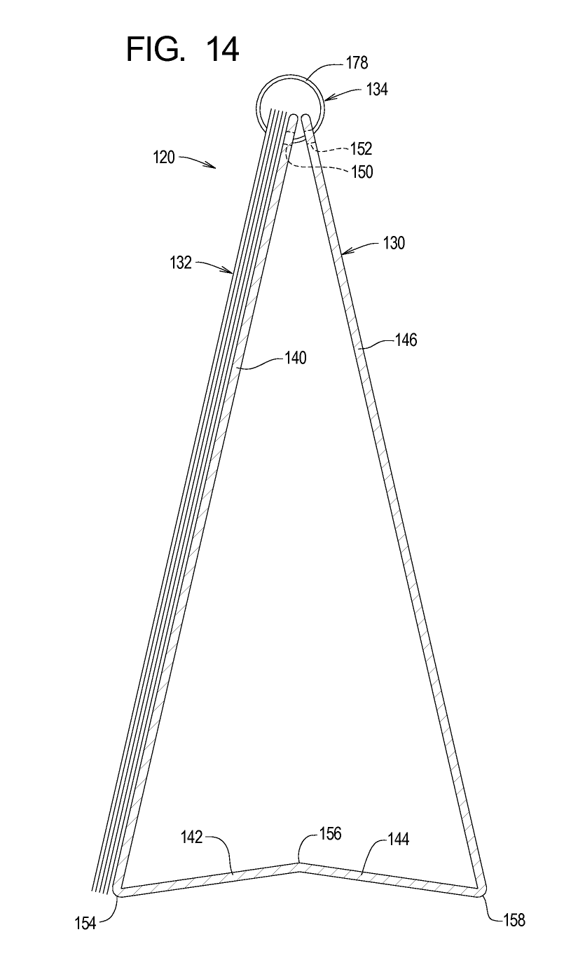

The example support board 130 is a relatively rigid card stock or plastic stock comprising first, second, third, and fourth panels 140, 142, 144, and 146. The first and fourth panels 140 and 146 define first and second sets 150 and 152 of binding holes. A first bend line 154 separates the first and second panels 140 and 142. A second bend line 156 separates the second and third panels 142 and 144. A third bend line 158 separates the third and fourth panels 144 and 146. The bend lines 154-158 allow the card stock to be folded in a storage/shipping configuration in which the panels 140-146 are substantially parallel as shown in FIG. 13 or to allow the first and fourth panels to extend at an angle with respect to each other in a display configuration as shown in FIG. 14.

Each of the display sheet assemblies 132 comprises a backing sheet 160, one or more cover sheets 162, one or more adhesive layers 164, and one or more release strips 166. The example backing sheet or sheets 160 are, like the support board, also made of relatively rigid card stock or plastic stock, although typically of lighter stock than the support board 130. The cover sheet or sheets 162 are typically relatively thin, flexible clear sheets of plastic or other suitable material that is at least partly transparent. The cover sheet 162 may be imprinted to define decorative or other borders and a viewing area.

A set 170 of backing sheet binding holes is formed in the backing sheet 160, while a set 172 of cover sheet binding holes is formed in each of the cover sheets 162. As is conventional, the first set, second set, backing sheet, and cover sheet binding holes or openings 150, 152, 170, and 172 are substantially aligned, and the example binding system 134 is a spiral binding wire 178 that extends through the aligned holes or openings 150, 152, 170, to and 172 to secure the display sheet assemblies 132 to the support board 130 in a generally conventional fashion.

The adhesive layer or layers 164 secure the cover sheet or sheets 162 to the backing sheet 160. Each cover sheet 162 defines, in conjunction with its associated adhesive layer 164 and backing sheet 160, a material opening 174 and a material chamber 176.

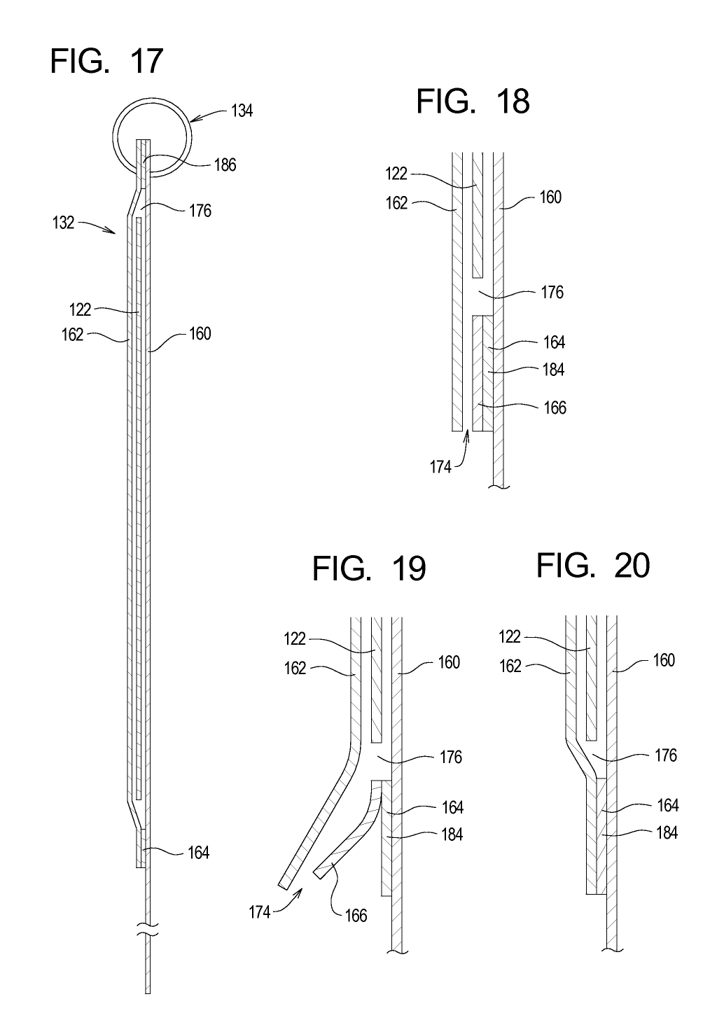

In one example of the invention, six or twelve backing sheets 160 are provided. In the case of six backing sheets, a cover sheet 162 is secured to each side of each backing sheet 160 to define twelve of the material chambers 176. In the case of twelve backing sheets, a single cover sheet 162 is attached to each backing sheet. In either case, one material chamber is defined for each month of the year. For clarity and ease of illustration, FIGS. 17-20 depict only one cover sheet 162 and adhesive layer 164 attached to the example backing sheet 160 depicted therein.

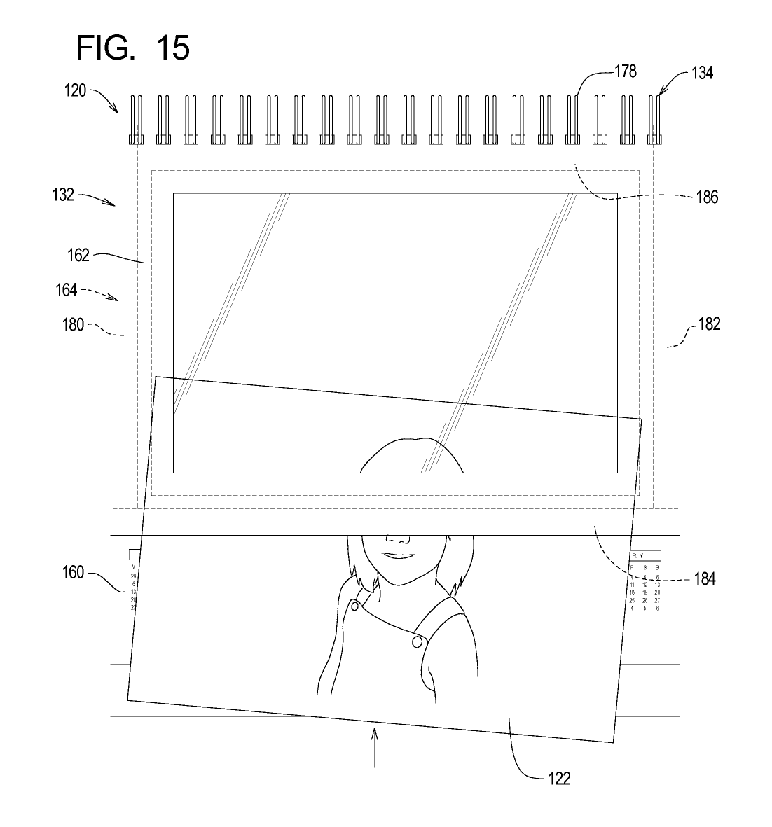

As perhaps best shown in FIG. 15, the adhesive layer 164 comprises first and second side edge portions 180 and 182, an open edge portion 184, and a closed edge portion 186. In the example desktop stationery item 120, the backing sheet binder openings 170 and cover sheet binding openings 172 at least partly overlap the closed edge portion 186 of the adhesive layer 164.

The release strip 166 is initially secured to the open edge portion 184 of the adhesive layer 164. Accordingly, the adhesive layer 164 initially secures the cover sheet 162 to the backing sheet 160 only along three edges such that the material opening 174 allows access to the material chamber 176. As shown in FIGS. 15 and 18, the supplemental material 122 may thus be inserted into the material chamber 176 through the material opening 174 when the release strip 166 is secured to the open edge portion 184 of the adhesive layer 184.

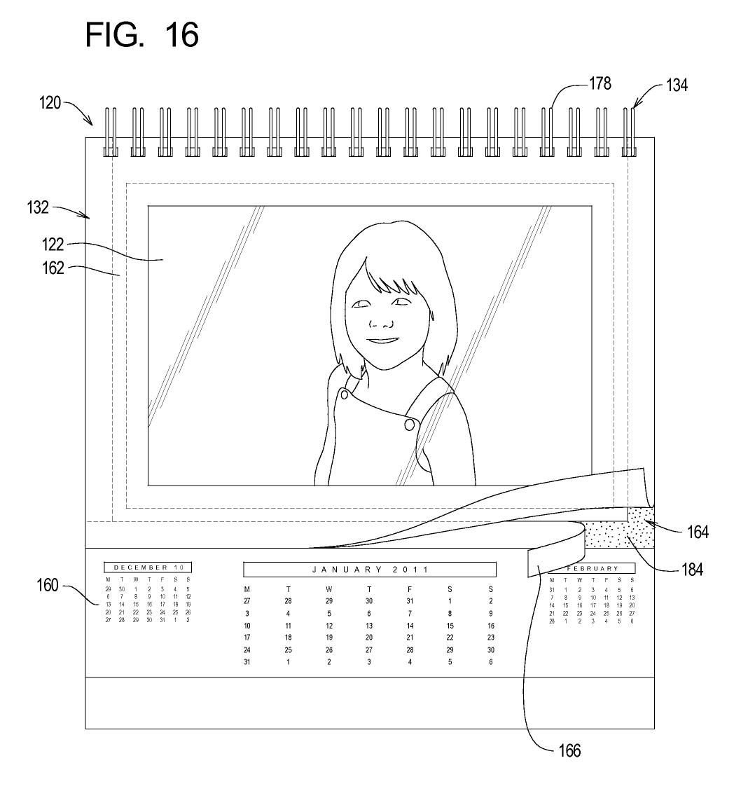

After the supplemental material 122 is within the material chamber 176, the release strip 166 may be removed as shown in FIGS. 16 and 19 to expose the open edge portion 184 of the adhesive layer 164. Allowing the cover sheet 162 to come into contact with the exposed open edge portion 184 of the adhesive layer 164 secures the cover sheet 162 to the backing sheet 160 and closes the material opening 174 as shown in FIG. 20. The supplemental material 122 is thus sealed within the material chamber 176 in FIG. 20.

The supplemental material 122 is this visible in a display portion 190 of the display sheet assembly 132, while a pre-printed portion 192 of the display sheet assembly 132 comprises text, numbers, graphics, or the like that may or may not be associated with the supplemental material 122. In the example desktop stationery item 120, the supplemental material 122 is a photograph of a girl, and the pre-printed portion 192 of the display sheet assembly 132 displays the birth month and day of the girl in the photograph.

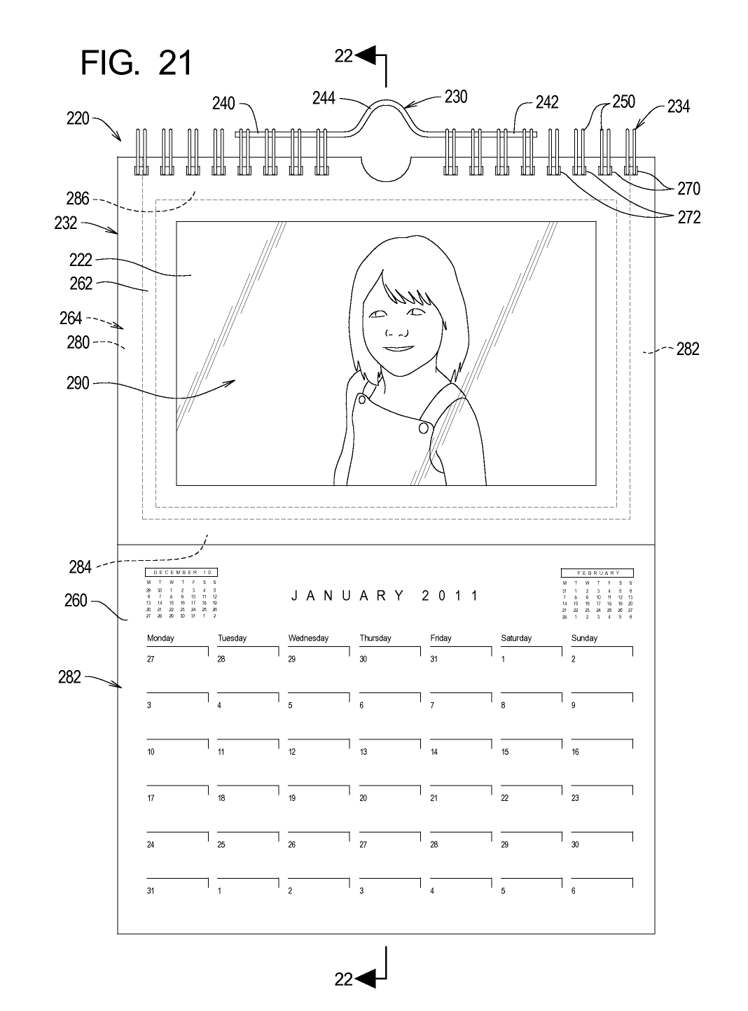

Turning now to FIGS. 21-26, depicted at 220 therein is an example hanging stationery item constructed in accordance, and embodying, the principles of the present invention in one form. supplemental material 222 is supported by the stationery item 220.

The example hanging stationery item 220 comprises a support rod 230, one or more display sheet assemblies 232, and a binding system 234. The example binding member 234 secures the display sheet assemblies 232 relative to each other and to the support rod 230.

The example support rod 230 is a relatively rigid metal or plastic wire defining a first lateral portion 240, a second lateral portion 242, and a middle portion 244. The lateral portions 240 and 242 engage the binding system 234 to allow the stationery item 220 to be hung from a hanging device (not shown) such as a nail or picture hanger. As will be described below, the example binding system 234 comprises one or more discrete or connected binding rings 250.

Each of the display sheet assemblies 232 comprises a backing sheet 260, one or more cover sheets 262, one or more adhesive layers 264, and one or more release strips 266. The example backing sheet or sheets 260 are made of relatively rigid card stock or plastic stock. The cover sheet or sheets 262 are typically relatively thin, flexible clear sheets of plastic or other suitable material that is at least partly transparent. The cover sheet 262 may be imprinted to define decorative or other borders and a viewing area.

A set 270 of backing sheet binding holes is formed in the backing sheet 260, while a set 272 of cover sheet binding holes is formed in each of the cover sheets 262. As is conventional, the backing sheet and cover sheet binding holes or openings 270 and 272 are substantially aligned, and binding rings 250 extend through the aligned holes or openings 270 and 272 to secure the display sheet assemblies 232 to the support rod 230 in a generally conventional fashion.

The adhesive layer or layers 264 secure the cover sheet or sheets 262 to the backing sheet 260. Each cover sheet 262 defines, in conjunction with its associated adhesive layer 264 and backing sheet 260, a material opening 274 and a material chamber 276.

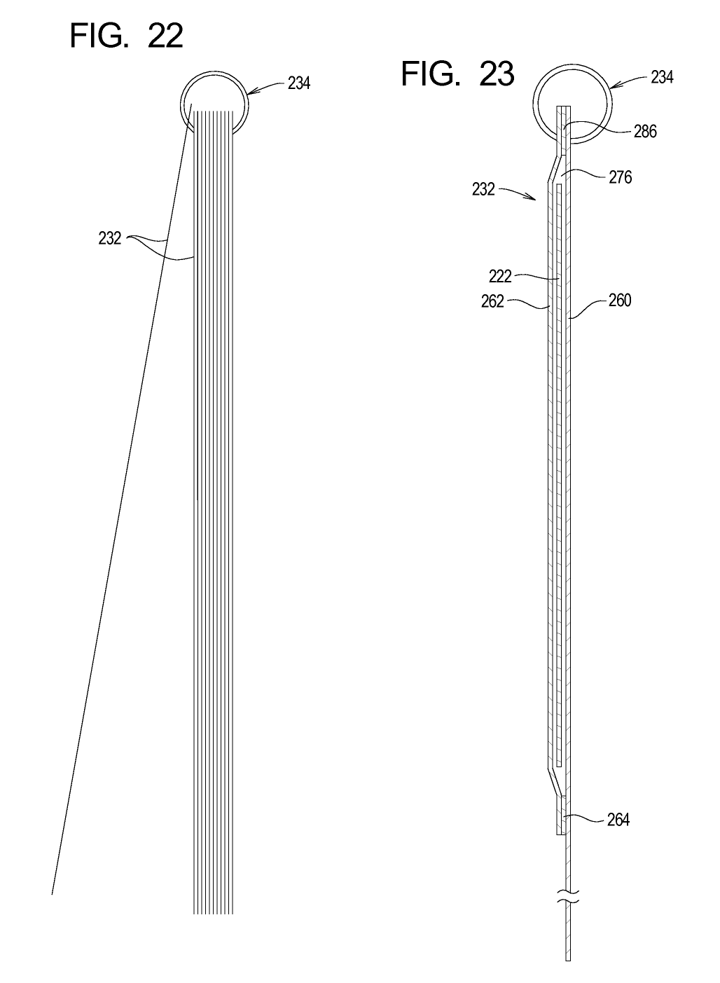

In one example of the invention as shown in FIGS. 22-26, twelve backing sheets 260 are provided, and a cover sheet 262 is secured to one side of each backing sheet 260 to define twelve of the material chambers 276, one for each month of the year.

As perhaps best shown in FIG. 21, the adhesive layer 264 comprises first and second side edge portions 280 and 282, an open edge portion 284, and a closed edge portion 286. In the example hanging stationery item 220, the backing sheet binder openings 270 and cover sheet binding openings 272 at least partly overlap the closed edge portion 286 of the adhesive layer 264.

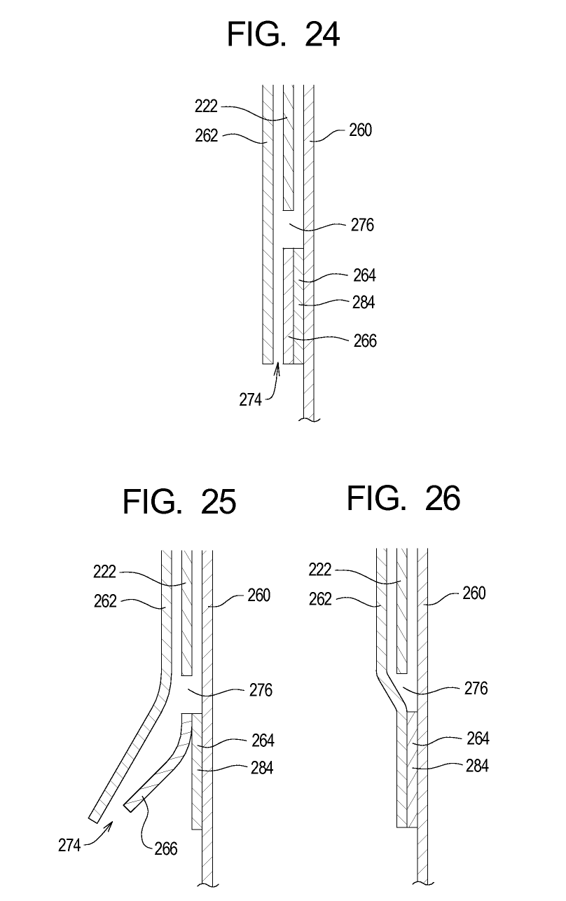

The release strip 266 is initially secured to the open edge portion 284 of the adhesive layer 284. Accordingly, the adhesive layer 264 initially secures the cover sheet 262 to the backing sheet 260 only along three edges such that the material opening 274 allows access to the material chamber 276. As shown in FIG. 24, the supplemental material 222 may thus be inserted into the material chamber 276 through the material opening 274 when the release strip 266 is secured to the open edge portion 284 of the adhesive layer 264.

After the supplemental material 222 is within the material chamber 276, the release strip 266 may be removed as shown in FIG. 25 to expose the open edge portion 284 of the adhesive layer 264. Allowing the cover sheet 262 to come into contact with the exposed open edge portion 284 of the adhesive layer 264 secures the cover sheet 262 to the backing sheet 260 and closes the material opening 274 as shown in FIG. 26. The supplemental material 222 is thus sealed within the material chamber 276 in FIG. 26.

The supplemental material 222 is thus visible in a display portion 290 of the display sheet assembly 232, while a pre-printed portion 282 of the display sheet assembly 232 comprises text, numbers, graphics, or the like that may or may not be associated with the supplemental material 222. In the example hanging stationery item 220, the supplemental material 222 is a photograph of a girl, and the pre-printed portion 282 of the display sheet assembly 232 displays the birth month and day of the girl in the photograph.

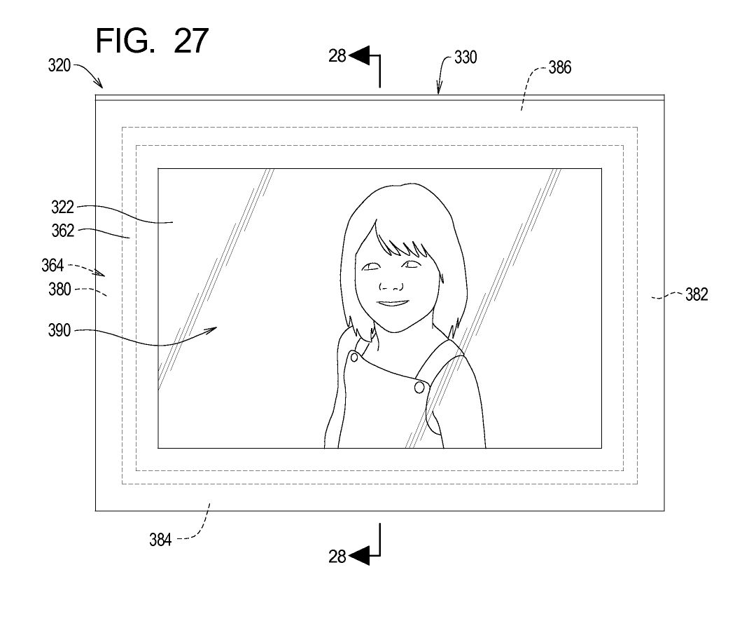

Turning now to FIGS. 27-31, depicted at 320 therein is an example hanging stationery item constructed in accordance, and embodying, the principles of the present invention in one form. supplemental material 322 is supported by the stationery item 320. The example folding stationery item 320 comprises a support card 330.

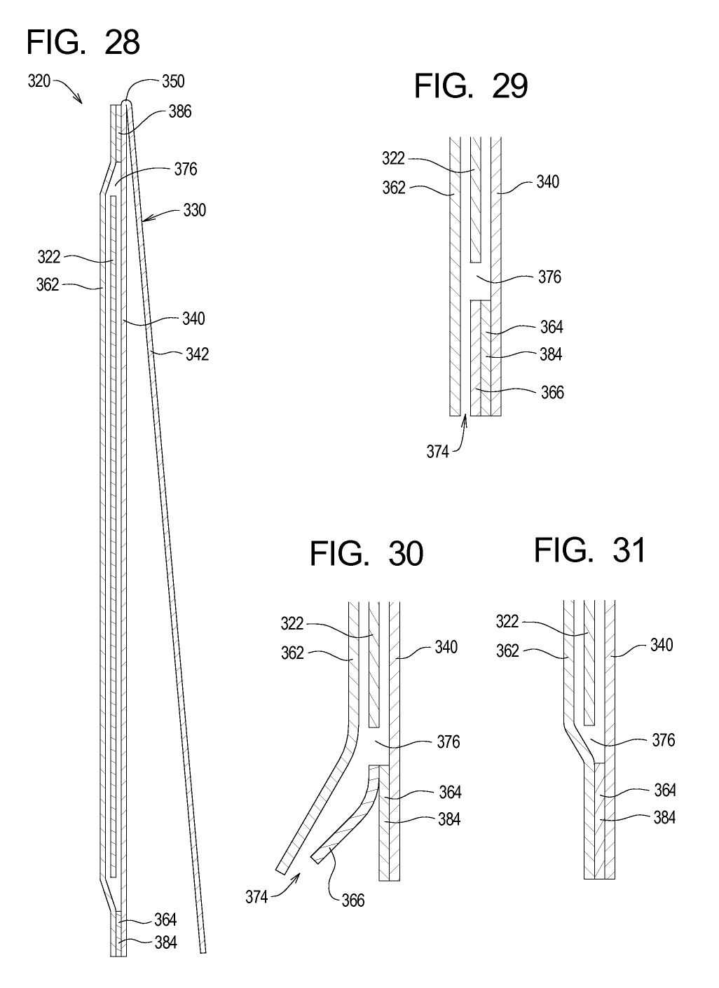

The example support card 330 is a relatively rigid card stock or plastic sheet defining a first panel 340 and a second panel 342. The first and second panels 340 and 342 are separated by a bend line 250. The bend line 250 allows the first and second panels 340 and 342 to folded into a closed configuration as shown in FIG. 28.

The folding stationery item 320 comprises, in addition to the support card 330, one or more cover sheets 362, one or more adhesive layers 364, and one or more release strips 366. The cover sheet or sheets 362 are typically relatively thin, flexible clear sheets of plastic or other suitable material that is at least partly transparent. The cover sheet 362 may be imprinted to define decorative or other borders and a viewing area.

The adhesive layer or layers 364 secure the cover sheet or sheets 362 to the first panel 340. Each cover sheet 362 defines, in conjunction with its associated adhesive layer 364 and support board 330, a material opening 374 and a material chamber 376.

As perhaps best shown in FIG. 27, the adhesive layer 362 comprises first and second side edge portions 380 and 382, an open edge portion 384, and a closed edge portion 386. The release strip 366 is initially secured to the open edge portion 374 of the adhesive layer 364 as shown in FIG. 29. Accordingly, the adhesive layer 364 initially secures the cover sheet 362 to the first portion 340 only along three edges such that the material opening 374 allows access to the material chamber 376. As shown in FIG. 29, the supplemental material 322 may thus be inserted into the material chamber 376 through the material opening 374 when the release strip 366 is secured to the open edge portion 384 of the adhesive layer 364.

After the supplemental material 322 is within the material chamber 376, the release strip 366 may be removed as shown in FIG. 30 to expose the open edge portion 384 of the adhesive layer 364. Allowing the cover sheet 362 to come into contact with the exposed open edge portion 384 of the adhesive layer 384 secures the cover sheet 362 to the first portion 340 and closes the material opening 374 as shown in FIG. 31. The supplemental material 322 is thus sealed within the material chamber 376 in FIG. 31. The supplemental material 322 is thus visible in a display portion 390.

The stationery items 120, 220, and 320 all may be manufactured using a similar manufacturing process. The backing sheet and face sheet are initially printed if desired. The adhesive material is then applied to the backing sheet to define first, second, third, and fourth portions. A release strip is then applied to the fourth portion of the adhesive material. The face sheet is then brought into contact with the first, second, and third portions of is the adhesive material to secure the face sheet to the backing sheet. The release strip prevents the face sheet from contacting and being secured to the backing sheet, defining an opening through which and chamber into which supplemental materials may be placed.

At the point of use, the supplemental material is inserted through the opening and into the chamber. The adhesive material is then removed to allow the face sheet to come into contact with the fourth portion of the adhesive material, thereby closing the opening and substantially sealing the supplemental material within chamber.

The present invention may thus be embodied in forms other than described above, and the scope of the present invention should be determined by the claims appended hereto and not the foregoing detailed description of the invention.

What is claimed is:

1. A customizable stationery item adapted to hold supplemental material, comprising:
at least one backing sheet;
adhesive material applied to the backing sheet to define first, second, third, and fourth portions arranged to define a material chamber;
a face sheet secured to the backing sheet by the first, second, and third portions of the adhesive material;
a release strip selectively engaged with the fourth portion of the adhesive material to define a material opening; whereby
after the supplemental material is inserted into the material chamber through the material opening, the release strip is removed to allow the face sheet to contact the fourth portion of the adhesive material, thereby closing the material opening.
